(19) United States
(12) Patent Application Publication
(10) Pub. No.: US 2010/0117777 A1
(43) Pub. Date: May 13, 2010

(54) Transformer

(75) Inventors: Top Tan, Dong-Guan City (CN); YL Xu, Dong-Guan City (CN)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/349,688

(22) Filed: Jan. 7, 2009

(30) Foreign Application Priority Data
Nov. 7, 2008 (TW) 097220016

(51) Int. Cl. H01F 5/00; H01F 27/06

(52) U.S. Cl. 336/65; 336/200

(57) ABSTRACT

A transformer that comprises a coil module, a core and two bases is provided. The core penetrates through the coil module. The two bases are respectively disposed on the opposite ends of the core to clamp the coil module. The coil module comprises a plurality of coils which are sequentially stacked. Each of the coils includes a plurality of PCBs which are electrically connected and sequentially stacked. Each of the PCBs is formed with a printed circuit in a spiral configuration with respect to the core. Each of the coils is formed by the electrically connected print circuits which are formed on the adjacent PCBs. Thus, the present invention provides a transformer with high efficiency and slimness.

This application claims the benefits of the priority based on Taiwan Patent Application No. 097220016 filed on Nov. 7, 2008, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention provides a transformer with high efficiency but a small volume.

2. Descriptions of the Related Art

As electronic technologies advance rapidly, the high-frequency transformers applied in various fields such as communication power supplies, base stations, DC-DC converters and the like are evolving towards smaller volume and higher power.

Conventional transformers are typically wound with flat wires, copper sheets or aluminum sheets plus insulation sheets. In conventional transformer structure, insulation sheets must be used between adjacent windings for insulation purposes. To accommodate for the multiple windings and turns for conducting strong operating currents, it is difficult to keep the volume of the transformer small, thereby increasing the thickness of the product. Furthermore, the large number of molds, complex assembly processes and lower level of automation result in increased costs.

In view of this, it is important to provide a transformer with high efficiency but a small volume.

### SUMMARY OF THE INVENTION

The objective of this invention is to overcome the drawbacks of the prior art by providing a transformer with a high power but a small volume and remarkably reduced cost.

The transformer of this invention has a plurality of printed circuit boards (PCBs) stacked with each other, wherein each of the PCBs is formed with a spiral printed circuit. Adjacent printed circuits are connected in series to form a coil so that the clearance between the windings is minimized to decrease the power loss, improve the efficiency and reduce the size.

Depending on the characteristics of the individual coils, the thickness of the printed circuits may be selectively increased to sustain a larger current and a higher voltage to meet the requirements of safety distance. Pins are made of phosphor bronze with good conductivity and moderate hardness, and are formed with an enlarged end to improve the flatness necessary for mounting on the surface of the transformer to ensure the feasibility and stability for high operation current. The pins are preferably coated with a silver layer on the surfaces thereof to enhance the conductivity of the pins. The square pads may be used on the top PCB while other PCBs may be provided with circular pads to control a better safety distance and wiring arrangement.

This invention provides a transformer, which comprises a coil module, a core and two bases. The core penetrates through the coil module. The two bases are respectively disposed on the two opposite ends of the core to clamp the coil module. The coil module comprises a plurality of coils which are sequentially stacked. Each of the coils includes a plurality of printed circuit boards (PCBs) which are electrically connected and sequentially stacked. Each of the PCBs is formed with a printed circuit that extends spirally with respect to the core, and electrically connected to the printed circuits of the adjacent PCB.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1 and 2 are schematic views of the transformer of this invention;

FIG. 3 is a schematic view illustrating the operational principals of the transformer of this invention; and

FIGS. 4 to 15 are schematic views of the individual PCB layers in the coil module 3.

### DESCRIPTION OF THE PREFERRED EMBODIMENT

Hereinafter, the embodiments of this invention will be described with reference to the attached drawings.

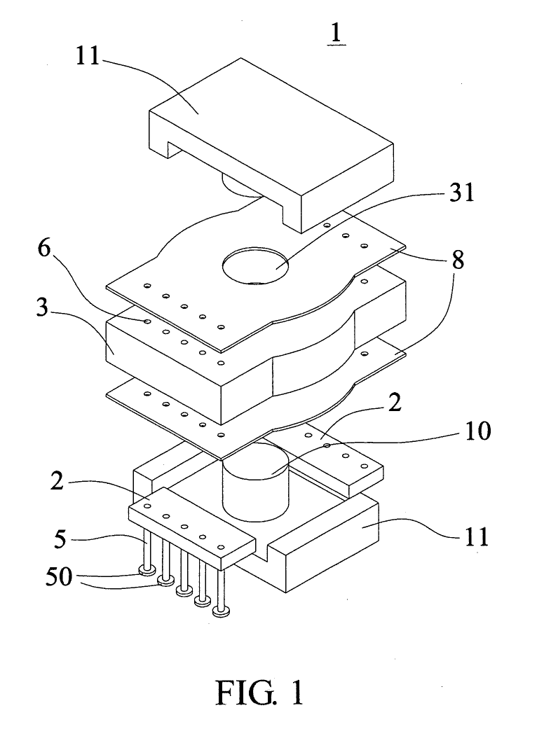

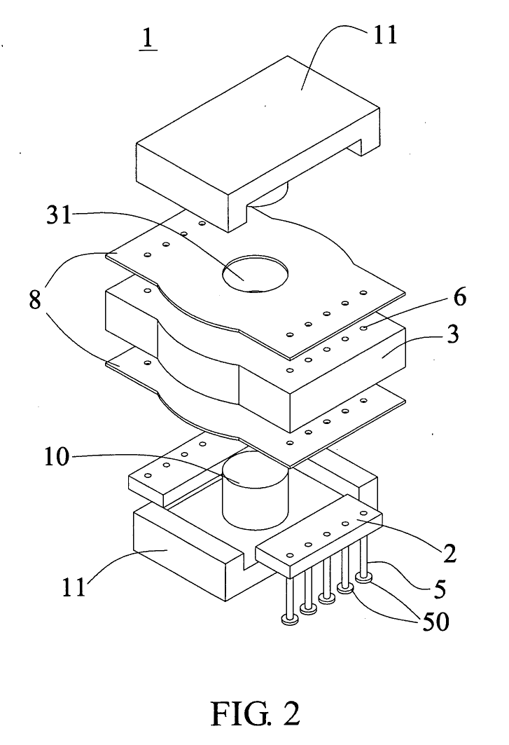

FIGS. 1 and 2 are schematic exploded views of a transformer 1 with high efficiency but a small volume. The transformer 1 comprises a core 10 penetrating through the through-hole 31 of a coil module 3. Two bases 11 are respectively connected to the two opposite ends of the core 10 to clamp the coil module 3. In this embodiment, the bases 11 and the core 10 are integrally formed.

The coil module 3 of this invention consists of a plurality of printed circuit boards (PCBs) which are electrically connected and sequentially stacked. Each of the PCBs is formed with a printed circuit, which extends spirally with respect to the core 10 and is electrically connected to the printed circuits of the adjacent PCB according to the design to form a plurality of coils sequentially stacked. Furthermore, each of the coils is formed by connecting the printed circuits of a plurality of adjacent PCBs in series.

To assemble the core 10, the bases 11 and the coil module 3, the bases 11 may be provided with two insulating fixed blocks 2 on opposite ends thereof respectively. Each of the insulating fixed blocks 2 comprises a plurality of pins 5 extending therefrom, while the coil module 3 comprises a plurality of holes 6 on the two opposite sides thereof with respect to the insulating fixed blocks 2 for the pins 5 to penetrate therethrough. Preferably, each of the pins 5 has an enlarged end 50 to improve the flatness necessary for mounting on the surface of the transformer. By inserting the core 10 into the through-holes 31 formed in each PCB of the coil module 3 and inserting the pins 5 that extend from the insulating fixed blocks 2 through the coil module 3, the pins 5 are electrically connected to the coil of the corresponding PCB.

In the preferred embodiment of this invention, each of the PCBs is formed on the outer edges thereof with ten corresponding holes arranged in two lines on both sides respectively, so that the holes 6 will be formed in the coil module 3 after the PCBs are stacked with each other. In this embodiment, ten pins 5 extend from the insulating fixed blocks 2 and penetrate through the holes 6 correspondingly. The pins 5 should be made of phosphor bronze and coated with a silver layer to improve electrical conductivity.

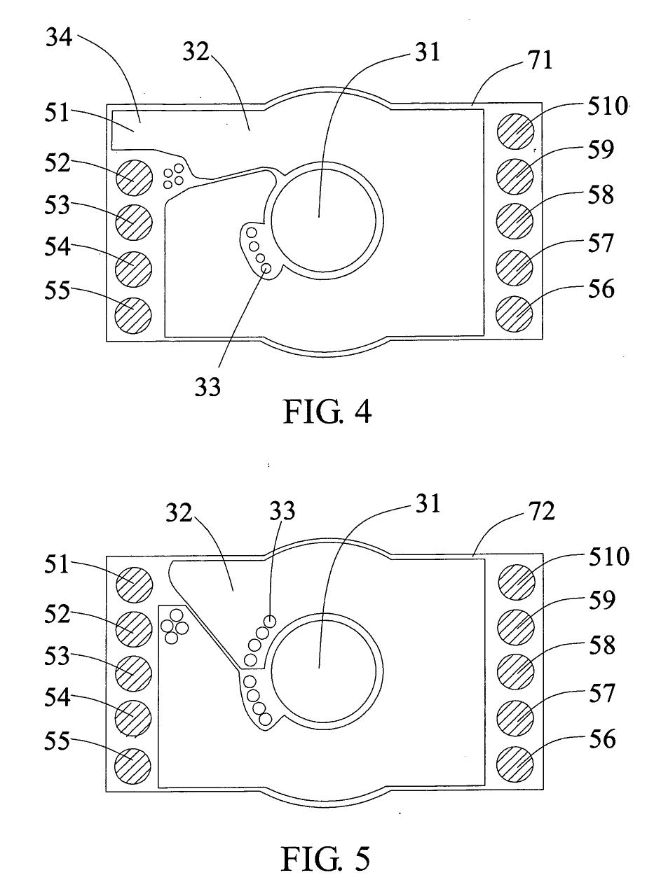

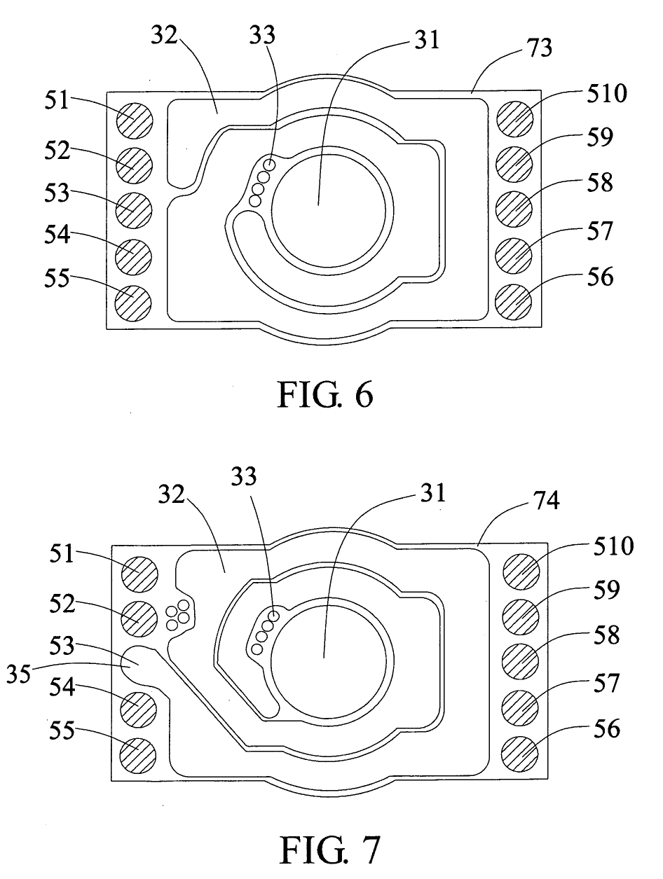

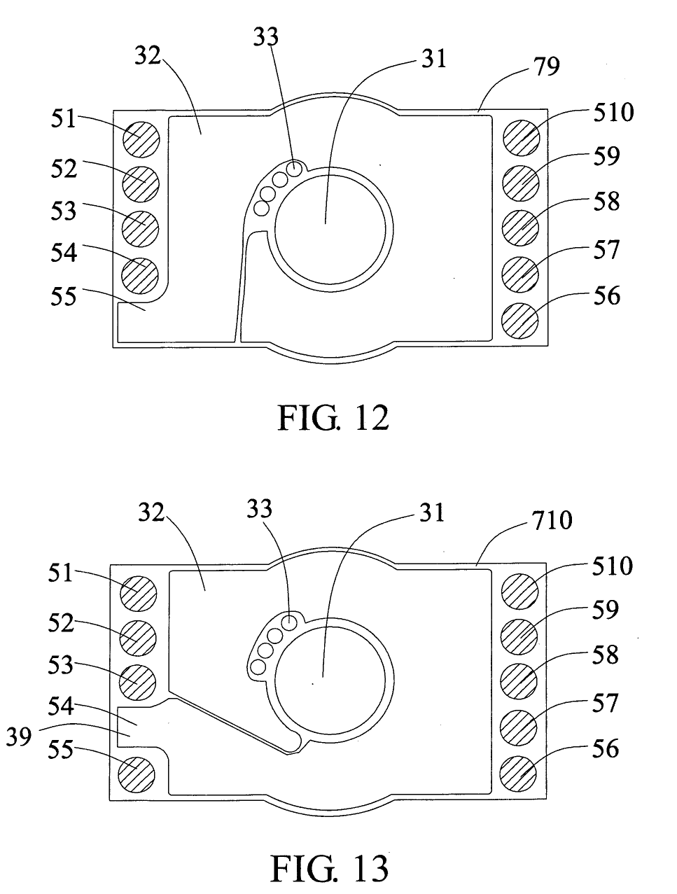

In the preferred embodiment, the coil module 3 comprises twelve PCBs stacked on and insulated from each other, as shown in FIGS. 4 to 15 respectively. In these PCBs, the printed circuits 32 formed on the first, second, seventh, eighth, ninth and tenth PCBs 71, 72, 77, 78, 79, 710 encircle the through-hole 31 in a configuration of single spiral, the printed circuits 32 formed on the third and fourth PCBs 73, 74 encircle the through-hole 31 in a configuration of double spirals, the printed circuits formed on the fifth and sixth PCBs 75, 76 encircle the through-hole 31 in a configuration of three spirals, and the printed circuits 32 formed on the eleventh and twelfth PCBs 711, 712 encircle the through-hole 31 in a configuration of seven spirals.

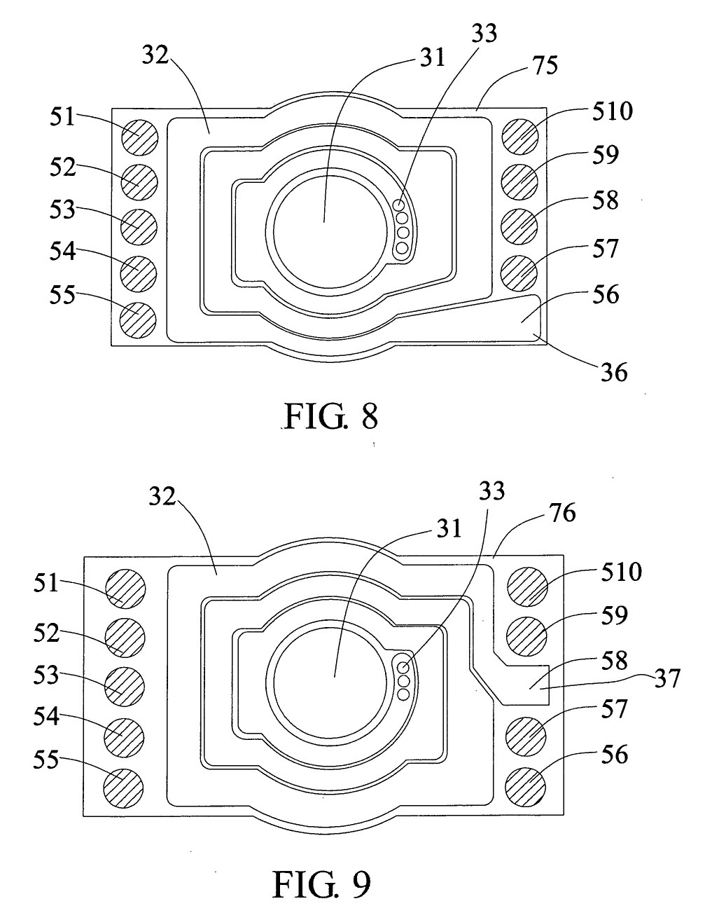

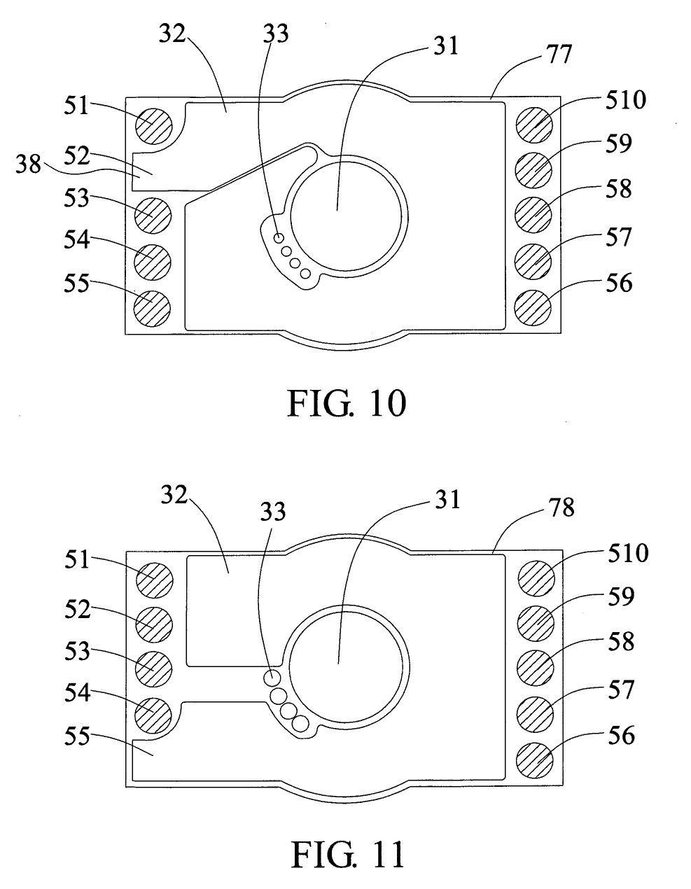

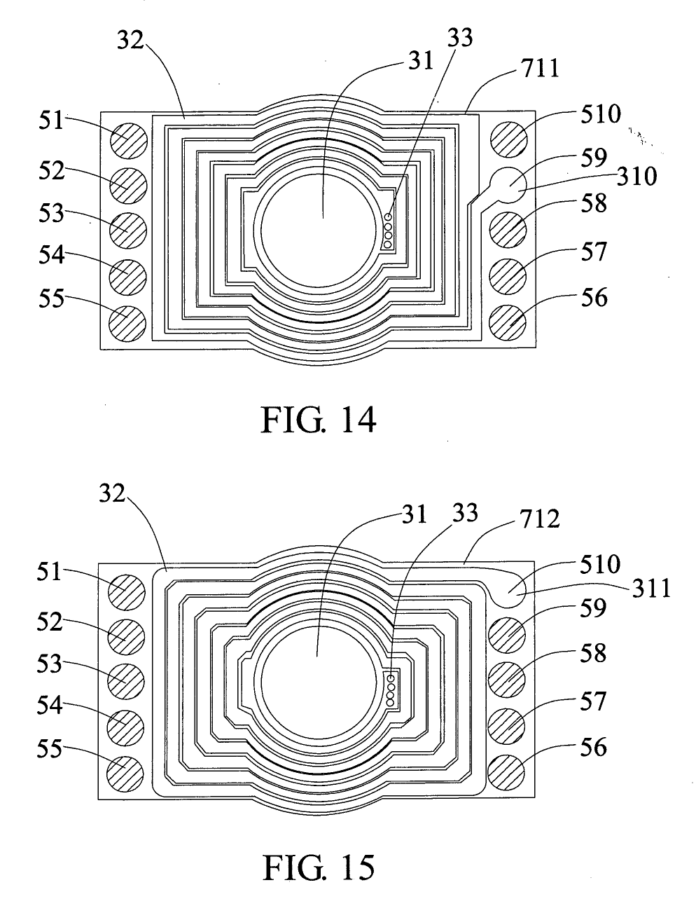

As shown in FIGS. 4 to 7, the printed circuits 32 formed on the first to the fourth PCBs 71, 72, 73, 74 are electrically connected through the via holes 33 thereof to form a first coil in a similar configuration of a spiral, in which the two conductive ends 34, 35 of the first coil are disposed with respect to the specific holes 6 to be electrically connected to the first and the third pins 51, 53. As shown in FIGS. 8 and 9, the printed circuits 32 formed on the fifth and the sixth PCBs 75, 76 are electrically connected through the via holes 33 thereof to form a second coil in a similar spiral configuration, in which two conductive ends 36, 37 of the second coil are disposed with respect to the specific holes 6 to be electrically connected to the sixth and the eighth pins 56, 58. As shown in FIGS. 10 to 13, the printed circuits 32 formed on the seventh to the tenth PCBs 77, 78, 79, 710 are electrically connected through both of the via holes 33 and the fifth pin 55 to form a third coil in a similar spiral configuration, in which the two conductive ends 38, 39 of the third coil are disposed with respect to specific holes 6 to be electrically connected to the second and the fourth pins 52, 54. As shown in FIGS. 14 and 15, the printed circuits 32 formed on the eleventh and the twelfth PCBs 711, 712 are electrically connected through via holes 33 thereof to form a fourth coil in a similar spiral configuration, in which two conductive ends 310, 311 of the fourth coil are disposed with respect to the specific holes 6 to be electrically connected to the ninth and the tenth pins 59, 510.

Each of the PCBs forming the coil module 3 is coated with an insulating layer on the surface thereof. An insulating gasket 8 is attached to the top surface and the bottom surface of the coil module 3 respectively, which is disposed between the coil module 3 and the bases 11 to enhance the insulation effect. The insulating gaskets 8 may be made of an eco-friendly organic material, although they are not merely limited thereto. Additionally, some of the PCBs (e.g. the seventh, eighth, ninth and tenth PCBs 77, 78, 79, 710) conduct a strong current to flow therethrough, and the printed circuits 32 thereon are made of etched thick copper plates. Additionally, the pads at the ends of the printed circuits 32 of each PCB are not limited in shape. For example, the ends of the printed circuit 32 on the first PCB 71 are soldered by means of square pads, while the ends of the printed circuits 32 on the other PCBs are soldered by means of circular pads. These may be designed by those of ordinary skill in the art according to the requirements on the safety distance and wiring arrangement, but are not limited thereto.

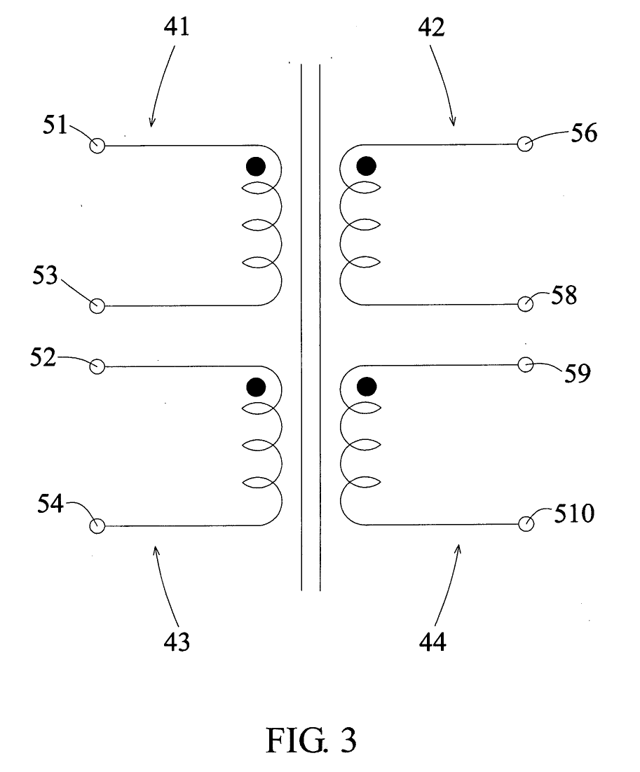

With the above arrangement, the working principles of the transformer 1 of this invention are shown in FIG. 3. The first coil 41 which consists of the first to the fourth PCBs 71, 72, 73, 74 is connected with the first and third pins 51, 53 correspondingly; the second coil 42 which consists of the fifth and the sixth PCBs 75, 76 is connected with the sixth and eighth pins 56, 58 correspondingly; the third coil 43 which consists of the seventh to the tenth PCBs 77, 78, 79, 710 is connected with the second and fourth pins 52, 54 correspondingly; and the fourth coil 44 which consists of the eleventh and the twelfth PCBs 711, 712 is connected with the ninth and tenth pins 59, 510 correspondingly. All the four coils encircle the core 10, such that the different effective voltages can be obtained in operation according to the turn ratios of the transformer by simply connecting the input current and output current to the corresponding pins.

It should be noted that in the transformer 1 described herein, the number of PCB layers in the transformer 1 is not limited to twelve, while the multi-layered structure of another number of layers may be designed (e.g., twenty or even more layers). The number of spirals of the printed circuits on each PCB is not limited, and may have a single spiral, three spirals, ten spirals or any other number of spirals. Similarly, the number of pins is not limited to ten, as illustrated in this invention, eighteen or twenty that may change depending the practical needs and design. In addition, the PCBs are also not limited in shape.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transformer, comprising:
a coil module;
a core penetrating through the coil module; and
two bases respectively disposed at two opposite ends of the core to clamp the coil module;
wherein the coil module comprises a plurality of coils which are sequentially stacked, each of the coils including a plurality of printed circuit boards (PCBs) which are electrically connected and sequentially stacked, and each of the PCBs is formed with a printed circuit spirally extending with respect to the core, and electrically connecting to the printed circuits of the adjacent PCB.

2. The transformer as claimed in claim 1, wherein each of the coils is connected by the printed circuits which are formed on the adjacent PCBs in series.

3. The transformer as claimed in claim 2, wherein the coil module is formed with a through-hole for the core penetrating therethrough.

4. The transformer as claimed in claim 3, wherein one of the bases is disposed with two insulating fixed blocks at opposite ends thereof respectively, each of the insulating fixed blocks comprising a plurality of pins extending thereon and the coil module comprising a plurality of holes formed at opposite sides thereof with respect to the insulating fixed blocks for the pins penetrating therethrough.

5. The transformer as claimed in claim 4, wherein each of the coils comprises two conductive ends with respect to the holes respectively electrically connecting to one of the pins.

6. The transformer as claimed in claim 4, wherein the pins are made of phosphor bronze and coated with a silver layer.

7. The transformer as claimed in claim 4, wherein each of the pins comprises an enlarged end.

8. The transformer as claimed in claim 1, wherein each of the PCBs is coated with an insulating layer.

9. The transformer as claimed in claim 1, further comprising two insulating gaskets disposed between the coil module and the bases.

10. The transformer as claimed in claim 8, wherein the insulating gaskets are made of eco-friendly organic material.

11. The transformer as claimed in claim 4, wherein the coil module comprises twelve PCBs, in which the printed circuits formed on the first to the fourth PCBs are connected through via holes thereof to form a first coil in a similar configuration of spiral, the printed circuits formed on the fifth and the sixth PCBs are connected through via holes thereof to form a second coil in a similar configuration of spiral, the printed circuits formed on the seventh to the tenth PCBs are connected through via holes thereof to form a third coil in a similar configuration of spiral, and the printed circuits formed on the eleventh and the twelfth PCBs are connected through via holes thereof to form a fourth coil in a similar configuration of spiral.

12. The transformer as claimed in claim 11, wherein the printed circuits formed on the first, second, seventh, eighth, ninth and tenth PCBs encircling the through-hole in a configuration of single spiral, the printed circuits formed on the third and fourth PCBs encircling the through-hole in a configuration of double spirals, the printed circuits formed on the fifth and sixth PCBs encircling the through-hole in a configuration of three spirals, and the printed circuits formed on the eleventh and twelfth PCBs encircling the through-hole in a configuration of seven spirals.

13. The transformer as claimed in claim 12, wherein the plurality of pins comprise ten pins, in which the conductive ends of the first coil are connected with the first and third pins, the conductive ends of the second coil are connected with the sixth and eighth pins, the conductive ends of the third coil are connected with the second and fourth pins, and the conductive ends of the fourth coil are connected with the ninth and tenth pins.

14. The transformer as claimed in claim 12, wherein the printed circuits formed on the seventh, eighth, ninth and tenth PCBs are made of etched thick copper plates for conducting strong current.
